(19) United States
(12) Patent Application Publication
(10) Pub. No.: US 2021/0406351 A1
(43) Pub. Date: Dec. 30, 2021

(54) NON-FACE-TO-FACE AUTHENTICATION SYSTEM

(71) Applicant: Fullstack Inc., Seoul (KR)

(72) Inventors: Sungho SON, Seoul (KR); Wonkyu LEE, Seoul (KR)

(73) Assignee: Fullstack Inc., Seoul (KR)

(21) Appl. No.: 17/349,842

(22) Filed: Jun. 16, 2021

(30) Foreign Application Priority Data
Jun. 30, 2020 (KR) 10-2020-0080473

(51) Int. Cl. G06F 21/32; G06K 9/00

(52) U.S. Cl. CPC G06F 21/32; G06K 9/00906; G06K 9/00248; G06K 9/00288; G06K 9/00281; G06K 9/00912

(57) ABSTRACT

The inventive concept relates to a non-face-to-face authentication system, which strengthens security of face recognition at the same time as complementing the vulnerability of the authentication process through existing face recognition without undermining the convenience of the user. For example, the non-face-to-face authentication system is disclosed that includes a first user authentication information registering unit that registers a plurality of user face images respectively captured at various angles, a user face image obtaining unit that notifies each of a plurality of pieces of image capture direction information for a user face and obtains each of user face images according to the image capture direction information by means of live image capture, and a first authentication processing unit that compares the user face images obtained by means of the user face image obtaining unit with user face images registered with the first user authentication information registering unit and determines whether authentication is completed according to the compared result.

### CROSS-REFERENCE TO RELATED APPLICATIONS

A claim for priority under 35 U.S.C. § 119 is made to Korean Patent Application No. 10-2020-0080473 filed on Jun. 30, 2020, in the Korean Intellectual Property Office, the entire contents of which are hereby incorporated by reference.

### BACKGROUND

Embodiments of the inventive concept described herein relate to a non-face-to-face authentication system.

A user performs business of a financial institution and a government office using the Internet, a real name of the user is identified by means of an identification (ID) card of the user. Authentication using an ID card may be to only query an institution which issues the ID card whether the ID card is falsified to determine whether the ID card is falsified. It is impossible to determine whether a person who submits the ID card is himself/herself or anyone else.

Meanwhile, a scheme of capturing a face of the user or the like and comparing it with a picture of the user, which is previously stored, is used to perform authentication. In this case, as another person prepares a picture of the user or the like in advance and presents it by means of a camera for image capture, he or she renders authentication useless.

Due to such problems, there is a request for a user authentication technology capable of determining the authenticity (“real name authentication”) of the ID card of the user and whether the user is himself/herself (“self-authentication”) together.

For example, the user performs business of a financial institution and a government office using the Internet, his/her real name is identified using a real-name certificate (e.g., an identification card, a license, a passport, or the like). However, authentication using the real-name certificate may be to only query an institution which issues the real-name certificate whether the real-name certificate is falsified to determine whether the real-name certificate is falsified. It is impossible to determine whether a person who submits the real-name certificate is himself/herself.

For example, there is a need for real-name verification and self-authentication when the user opens a non-face-to-face account in existing financial institutions, Internet only banks, and the like. Furthermore, it is required to identify himself/herself upon continuous transaction.

### PRIOR ART DOCUMENTS

### Patent Documents

(Patent Document 1) Korean Patent No. 10-1738593 (Publication Date: May 16, 2017)

(Patent Document 2) Korean Patent Laid-open Publication No. 10-2017-0052903 (Publication Date: May 15, 2017)

### SUMMARY

Embodiments of the inventive concept provide a non-face-to-face authentication system for strengthening security of face recognition at the same time as complementing the vulnerability of the authentication process through existing face recognition without undermining the convenience of a user.

According to an exemplary embodiment, a non-face-to-face authentication system may include a first user authentication information registering unit that registers a plurality of user face images respectively captured at various angles, a user face image obtaining unit that notifies each of a plurality of pieces of image capture direction information for a user face and obtains each of user face images according to the image capture direction information by means of live image capture, and a first authentication processing unit that compares the user face images obtained by means of the user face image obtaining unit with user face images registered by means of the first user authentication information registering unit for each image capture direction and determines whether a user is authenticated according to the compared result.

Furthermore, the non-face-to-face authentication system may further include a second user authentication information registering unit that registers identification (ID) card image of the user, a user ID card image obtaining unit that obtains a user ID card image by means of the live image capture, and a second authentication processing unit that compares the user ID card image obtained by means of the user ID card image obtaining unit with the user ID card image registered by means of the second user authentication information registering unit and additionally determines whether the user authenticated according to the compared result.

Furthermore, the first user authentication information registering unit may include a user face image registration guidance unit that guides the user to capture user face images for every a plurality of different image capture angles and a user face image learning and storing unit that classifies and receives user face images captured by means of an image capture means depending on guidance through the user face image registration guidance unit, extracts and learns feature points of a user face from the user face image classified for each image capture angle, and stores the learned data.

Furthermore, the user face image registration guidance unit may guide the user through a plurality of different candidate image capture angles and may allow the user to select at least two or more of the guided candidate image capture angles to perform image capture, or may interwork with a social network system (SNS) of the user to analyze an image capture angle for a portrait among profile pictures of the SNS and may guide the user to designate an image capture angle of lowest frequency as an essential image capture angle and perform image capture depending on the analyzed result.

Furthermore, the user face image obtaining unit may include an image capture direction information generator that generates the plurality of pieces of image capture direction information about the user face and randomly generates an image capture order for an image capture direction, an image capture guidance message providing unit that generates and provides an image capture guidance message according to the image capture direction information generated by the image capture information generator, and a user face image storing unit that sequentially obtains user face images according to the image capture guidance message by means of an image capture means, determines whether the obtained user face image is a user face image according to the image capture guidance message, outputs the image capture guidance message again to obtain a user face image suitable for an image capture angle, when a user face image different from an image capture direction is obtained, and matches and stores the obtained user face image and image capture direction information included in the image capture guidance message.

Furthermore, the first authentication processing unit may include a user face similarity calculating unit that compares feature points in the user face image for each image capture direction, the user face image being captured and stored by means of the user face image storing unit, with feature points in the user face image registered by means of the user face image obtaining unit and calculates a similarity between the feature points and an authentication determining unit that completes the authentication of the user, when the similarity for each user face image or each image capture angle, the similarity being calculated by means of the user face similarity calculating unit, is greater than or equal to a predetermined reference similarity.

Furthermore, the first user authentication information registering unit may additionally register at least one of a specific look and a finger gesture as user authentication information, the specific look and a finger gesture being included in the user face image, when registering the user face image. The user face image obtaining unit may notify additional authentication information of at least one of the specific look and the finger gesture together, when notifying the image capture direction information, to obtain a user face image including the additional authentication information.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic view illustrating the entire composition and operation of a non-face-to-face authentication system according to an embodiment of the inventive concept;

FIG. 2 is a block diagram illustrating a configuration of a non-face-to-face authentication system according to an embodiment of the inventive concept;

FIG. 3 is a block diagram illustrating a configuration of a first user authentication information registering unit according to an embodiment of the inventive concept;

FIG. 4 is a block diagram illustrating a configuration of a user face image obtaining unit according to an embodiment of the inventive concept;

FIGS. 5, 6, 7, and 8 are drawings illustrating examples of a running screen of a user face image obtaining unit according to an embodiment of the inventive concept;

FIG. 9 is a block diagram illustrating a configuration of a first authentication processing unit according to an embodiment of the inventive concept;

FIG. 10 is a drawing illustrating an example of an operation screen of a user ID card image obtaining unit according to an embodiment of the inventive concept; and

FIG. 11 is a drawing illustrating an example of an operation screen for an authentication processing result through a first authentication processing unit and a second authentication processing unit according to an embodiment of the inventive concept.

### DETAILED DESCRIPTION

Terms used herein will be described in brief, and the inventive concept will be described in detail.

As for the terms used herein, general terms currently widely used are selected while considering functions in the inventive concept, but the terms may vary according to an intention or precedent of one of ordinary skill in the art, or the advent of new technology. Also in some cases, an applicant may have arbitrarily selected a term that may be described in detail in the detailed description of the inventive concept. Accordingly, the terms used herein should be defined based on the meaning and descriptions throughout the inventive concept, and not simply based on the term itself.

When a portion “includes” a component throughout the specification, another component may be further included without excluding the other component, unless specifically described otherwise. Also, the terms “unit” and “module” used herein mean a unit of processing at least one function or operation, which may be realized in hardware, software, or a combination of hardware and software.

Hereinafter, embodiments of the inventive concept will now be described in detail with reference to the accompanying drawings such that those skilled in the art to which the inventive concept belongs may easily execute it. However, the inventive concept may be implemented in several different forms and is not limited to the embodiments described herein. A portion not associated with a description will be omitted to clearly describe the inventive concept in the drawings, and a similar reference numeral is attached to a similar portion throughput the specification.

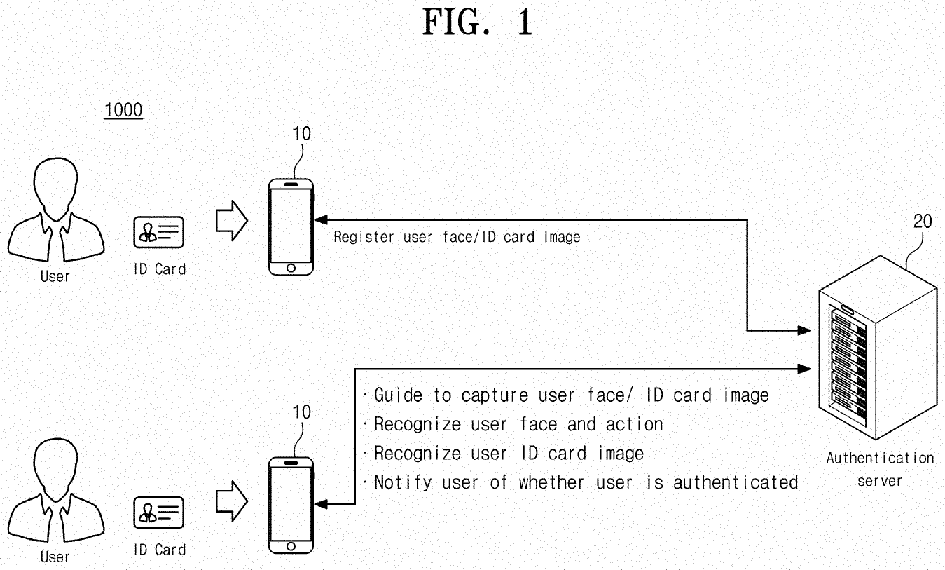

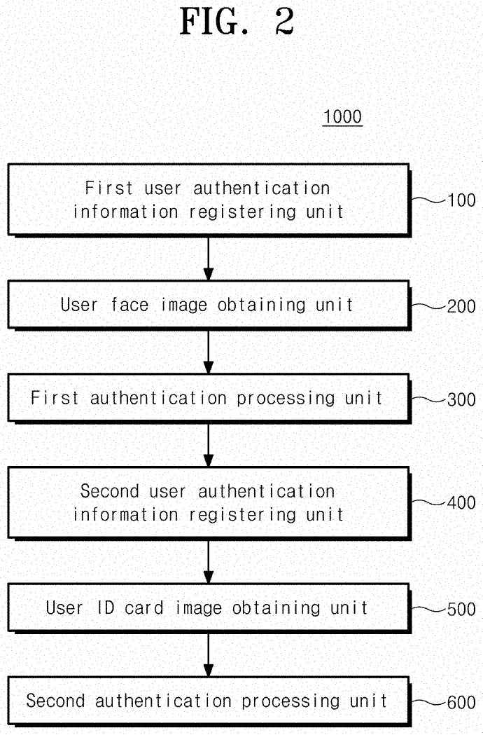

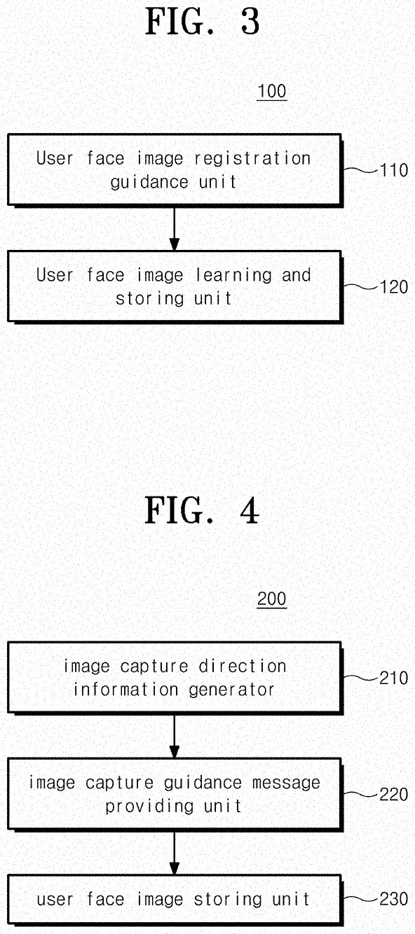

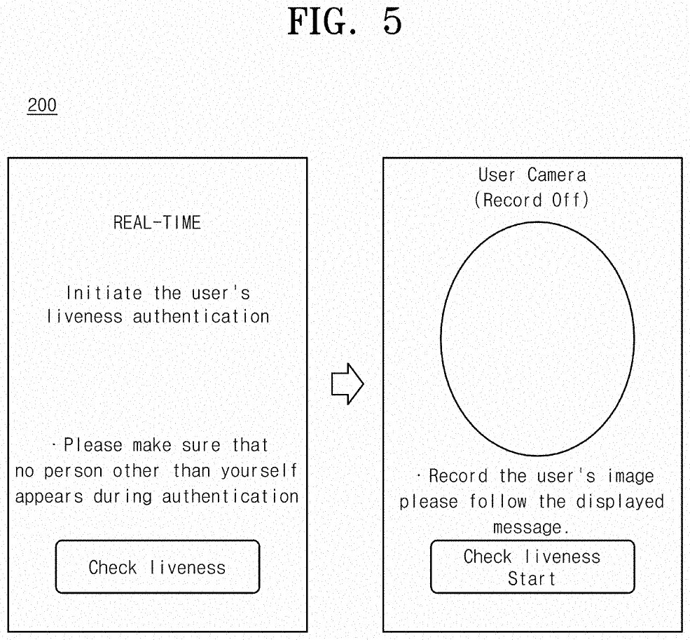

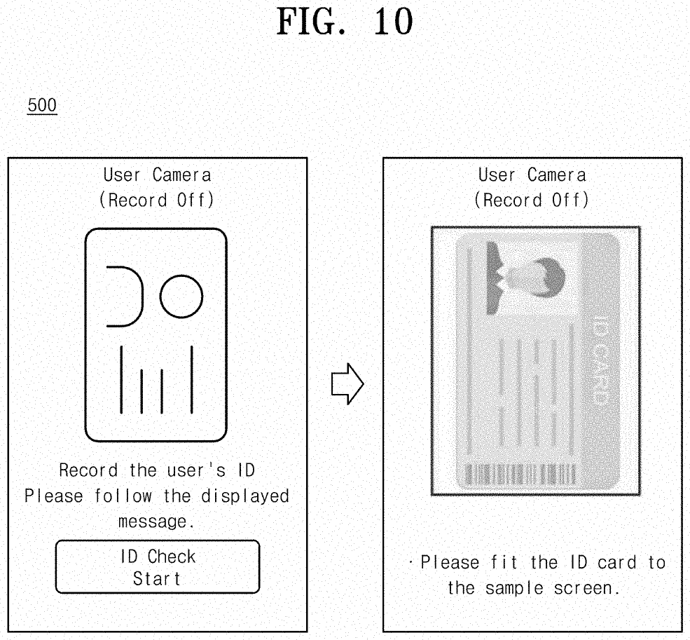

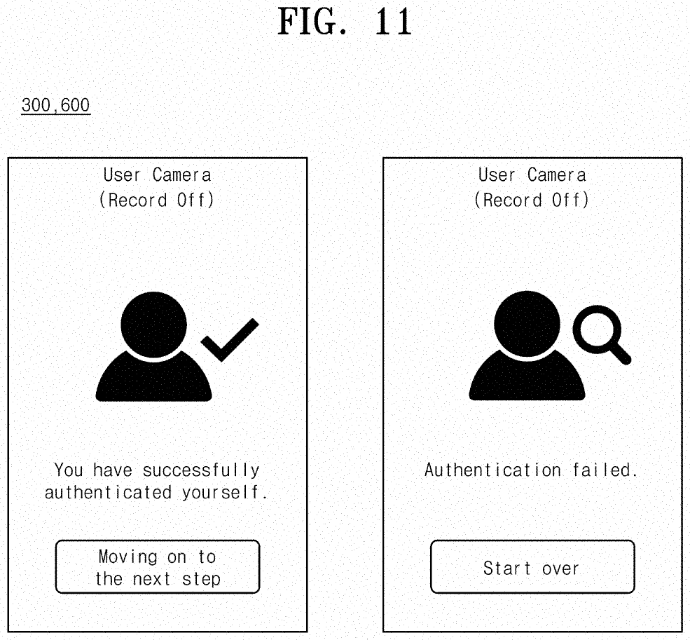

FIG. 1 is a schematic view illustrating the entire composition and operation of a non-face-to-face authentication system according to an embodiment of the inventive concept. FIG. 2 is a block diagram illustrating a configuration of a non-face-to-face authentication system according to an embodiment of the inventive concept. FIG. 3 is a block diagram illustrating a configuration of a first user authentication information registering unit according to an embodiment of the inventive concept. FIG. 4 is a block diagram illustrating a configuration of a user face image obtaining unit according to an embodiment of the inventive concept. FIGS. 5 to 8 are drawings illustrating examples of a running screen of a user face image obtaining unit according to an embodiment of the inventive concept. FIG. 9 is a block diagram illustrating a configuration of a first authentication processing unit according to an embodiment of the inventive concept. FIG. 10 is a drawing illustrating an example of an operation screen of a user ID card image obtaining unit according to an embodiment of the inventive concept. FIG. 11 is a drawing illustrating an example of an operation screen for an authentication processing result through a first authentication processing unit and a second authentication processing unit according to an embodiment of the inventive concept.

Referring to FIGS. 1 and 2, a non-face-to-face authentication system 1000 according to an embodiment of the inventive concept may include at least one of a first user authentication information registering unit 100, a user face image obtaining unit 200, a first authentication processing unit 300, a second user authentication information registering unit 400, a user ID card image obtaining unit 500, and a second authentication processing unit 600.

The first user authentication information registering unit 100 may register a plurality of user face images respectively captured at various angles. To this end, as shown in FIG. 3, the first user authentication information registering unit 100 may include a user face image registration guidance unit 110 and a user face image learning and storing unit 120.

The user face image registration guidance unit 110 may guide a user to capture user face images for every a plurality of different image capture angles.

In detail, the user face image registration guidance unit 110 may guide the user through a plurality of different candidate image capture angles and may allow the user to select at least two or more of the guided candidate image capture angles to perform image capture. For example, the user face image registration guidance unit 110 may output a guidance message such that the user may take a frontal picture, a side picture, or a 45-degree lateral picture and such that the user may obtain a plurality of pictures for each angle by performing image capture several times depending on the guidance message.

Furthermore, the user face image registration guidance unit 110 may interwork with a social network system (SNS) of the user to analyze an image capture angle for a portrait among profile pictures of the SNS and may guide the user to designate an image capture angle of lowest frequency as an essential image capture angle and perform image capture depending on the analyzed result. In other words, because the face picture of the user has been released as a profile picture of the SNS or the like, the user face image registration guidance unit 110 may interwork with an SNS of the user to collect a profile picture of a corresponding account, may analyze an angle at which a face in a portrait in the profile picture is captured. For example, when there is no picture at an angle where side image capture is performed or when a picture at an angle where side image capture is performed has the lowest frequency such as one time, the user face image registration guidance unit 110 may include the picture of the image capture angle in a guidance message to be essentially captured and may allow the user to register a face image of the image capture angle.

The user face image learning and storing unit 120 may classify and receive user face images captured by means of an image capture means (e.g., a camera) of a user communication terminal 10 for each image capture angle depending on the guidance through the user face image registration guidance unit 110, may extract and learn feature points for a user face from the user face image classified for each image capture angle, and may store the learned data. Such a user face image learning and storing unit 120 may classify the user face images obtained according to the above-mentioned guidance message for each guidance message or each image capture angle, may extract feature points for a user face in the classified user face image using a deep learning-based artificial intelligence (AI) algorithm, and may store and manage the extracted feature points as user authentication information for each classification criterion.

The user face image obtaining unit 200 may notify the user of a plurality of pieces of image capture direction information for the user face and may obtain each of user face images according to the plurality of pieces of the image capture information by means of live image capture. To this end, as shown in FIG. 4, the user face image obtaining unit 200 may include an image capture direction information generator 210, an image capture guidance message providing unit 220, and a user face image storing unit 230.

The image capture direction information generator 210 may generate a plurality of pieces of image capture direction information for the user face, which may randomly generate an image capture order for an image capture direction. For example, the image capture direction information generator 210 may generate image capture direction information in an image capture direction and order of “a front, a left side, and a 45-degree left direction” and may generate image capture direction information in an image capture direction and order of “a right side, a front, and a 45-degree right direction”. Furthermore, the image capture direction information generator 210 may randomly generate at least two image capture directions and orders as well as three image capture directions and orders.

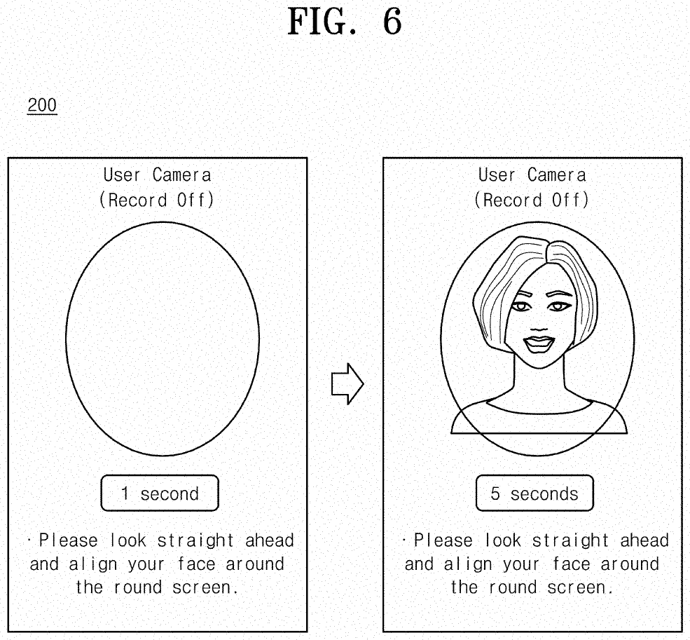

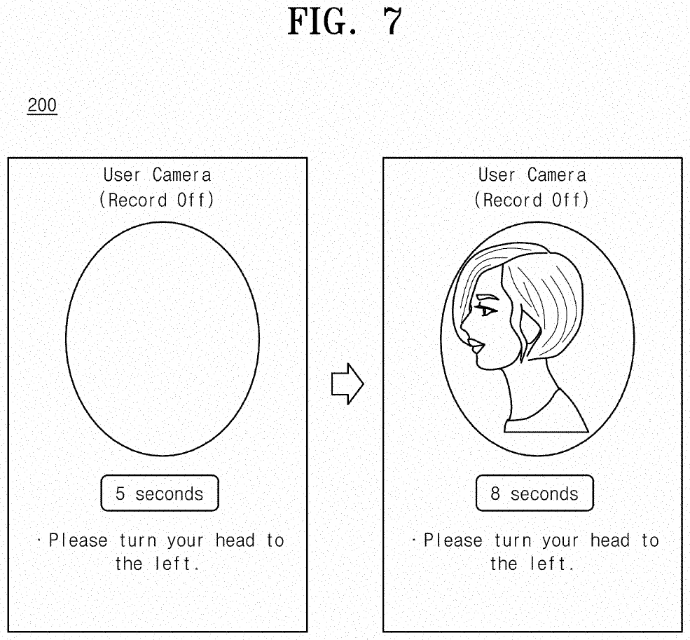

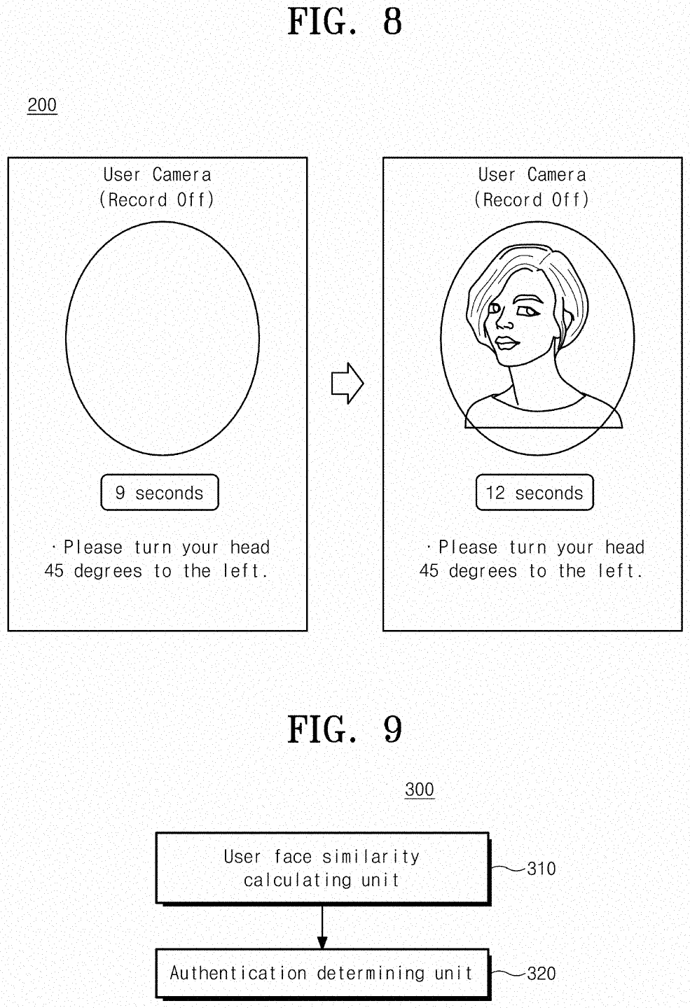

The image capture guidance message providing unit 220 may generate and provide an image capture guidance message according to the image capture direction information generated by the image capture direction information generator 210. For example, as shown in FIG. 5, when an application for performing authentication of the user is activated in real time, the image capture guidance message providing unit 220 may allow the user to show his or her face within a specific region displayed on the screen using the camera of the user communication terminal 10 and proceed with image capture. The image capture guidance message providing unit 220 may provide a frontal picture image capture guidance message shown in FIG. 6, a left side picture image capture guidance message shown in FIG. 7, and a 45-degree left lateral picture image capture guidance message shown in FIG. 8, during image capture, and may guide the user to perform image capture for each stage. Of course, an order for the above-mentioned image capture direction may be randomly determined. As a limited time is set upon image capture, the image capture guidance message providing unit 220 may guide the user to perform image capture within the limited time.

The user face image storing unit 230 may sequentially obtain user face images according to the image capture guidance message by means of the image capture means (e.g., the camera) of the user communication terminal 10. For example, the user face image storing unit 230 may sequentially proceed with primary image capture according to the frontal picture image capture guidance message shown in FIG. 6, secondary image capture according to the left side picture image capture guidance message shown in FIG. 7, and tertiary image capture according to the 45-degree left lateral picture image capture guidance message shown in FIG. 8 for each stage and may match and store the obtained user face image and the image capture direction information included in the image capture guidance message.

Herein, the user face image obtaining unit 200 may determine whether the obtained user face image is a user face image according to the image capture guidance message and may output the image capture guidance message again to obtain a user face image suitable for an image capture angle, when a user face image different from an image capture direction is obtained (e.g., when frontal picture image capture is required, but a side picture is captured). Furthermore, when an image is not obtained within an image capture time for each predetermined angle, the user face image obtaining unit 200 may output a re-image capture request message such that the face image is captured again.

The first authentication processing unit 300 may compare each of user face images obtained by means of the user face image obtaining unit 200 with user face images registered by means of the first user authentication information registering unit 100 for each image capture direction and may determine whether the user is authenticated according to the compared result. To this end, as shown in FIG. 9, the first authentication processing unit 300 may include a user face similarity calculating unit 310 and an authentication determining unit 320.

The user face similarity calculating unit 310 may compare feature points in the user face image for each image capture direction, which is captured and stored by means of the user face image storing unit 230, with feature points in a user face image previously registered by means of the user face image obtaining unit 200 and may calculate a similarity between the feature points. For example, for a frontal picture, the user face similarity calculating unit 310 may compare feature points between the previously stored frontal picture with a frontal picture captured and obtained in real time and may digitize the compared result to calculate a similarity point.

When the similarity for each user face image or each image capture angle, which is calculated by the user face similarity calculating unit 310, is greater than or equal to a predetermined reference similarity, the authentication determining unit 320 may complete the authentication of the user.

For example, when the calculated similarity point is greater than or equal to a predetermined reference point, the authentication of the frontal picture may be completed. Such a process may proceed in the same manner for pictures of other angles, that is, a side picture and the like. When a condition where all are greater than or equal to the reference point should be satisfied, the authentication of the face image may be finally completed. Herein, when the authentication of a face image at any one angle fails, the entire authentication may fail or only the face image may be captured again to partially perform authentication again.

The second user authentication information registering unit 400 may register an identification (ID) card image of the user. As such, upon the registration of the ID card image, only a frontal picture may be registered unlike the user face registration process. When the image is unfocused or when a recognition error for objects (e.g., an identification picture, text, a bar code, a quick response (QR) code, and the like) in the image occurs, the second user authentication information registering unit 400 may perform image capture again and may register an ID card image of the user. Furthermore, when registering the ID card image of the user, the second user authentication information registering unit 400 may recognize and store each of the objects (e.g., the identification picture, the text, the bar code, the QR code, and the like) in the image such that the stored objects may be used when the ID card is authenticated later.

The user ID card image obtaining unit 500 may obtain an ID card image of the user by means of live image capture. Upon the authentication, image capture of the ID card of the user may be performed and processed in real time in the same manner as the above-mentioned image capture of the user face image. As shown in FIG. 10, the user ID card image obtaining unit 500 may capture an ID card of the previously registered user to enter a specific region on the screen to obtain the ID card image of the user.

The second authentication processing unit 600 may compare the user ID card image obtained by means of the user ID card image obtaining unit 500 with the user ID card image registered by means of the second user authentication information registering unit 400 and may additionally determine whether the user is authenticated according to the compared result. For example, the second authentication processing unit 600 may newly recognize an object (e.g., an identification picture, text, a bar code, a QR code, or the like) in the user ID card image, may compare the recognized object with an object (e.g., an identification picture, text, a bar code, a QR code, or the like) in an ID card image of the previously registered user, and may determine whether the respective objects are identical to each other to numerically calculate a similarity point. In this case, when the calculated similarity point is greater than or equal to a predetermined reference similarity point, the ID card authentication of the user may be completed.

Meanwhile, upon the registration of the user face image, the first user authentication information registering unit 100 may additionally register at least one of a specific look and a finger gesture as user authentication information, which are included in the user face image. For example, the first user authentication information registering unit 100 may allow the user to define unique additional visual authentication information, such as a gesture to raise the thumb of the right finger and place it on the right cheek or an expression that sticks out his or her tongue, as an additional option for the user face image and may separately and additionally store an image for the unique additional visual authentication information.

Thus, the user face image obtaining unit 200 may notify the user of additional authentication information of at least one of the specific look and the finger gesture set by means of the first user authentication information registering unit 100 together, when notifying the user of the image capture direction information to obtain a user face image including the additional authentication information. The first authentication processing unit 300 may calculate a similarity between the additional authentication information with previously registered additional authentication information, may compare the calculated similarity with a reference similarity to perform additionally authentication.

According to embodiments of the inventive concept, the a non-face-to-face authentication system may be provided to strengthen security of face recognition at the same time as complementing the vulnerability of the authentication process through existing face recognition without undermining the convenience of the user.

Describing above is merely one embodiment for executing the non-face-to-face authentication system according to an embodiment of the inventive concept. While the inventive concept has been particularly shown and described with reference to exemplary embodiments thereof, it will be understood by those skilled in the art that various changes in form and details may be made therein without departing from the spirit and scope of the inventive concept as defined by the appended claims.

What is claimed is:

1. A non-face-to-face authentication system, comprising:
a first user authentication information registering unit configured to register a plurality of user face images respectively captured at various angles;
a user face image obtaining unit configured to notify each of a plurality of pieces of image capture direction information for a user face and obtain each of user face images according to the image capture direction information by live image capture; and
a first authentication processing unit configured to compare the user face images obtained by the user face image obtaining unit with user face images registered by the first user authentication information registering unit for each image capture direction and determine whether a user is authenticated according to the compared result.

2. The non-face-to-face authentication system of claim 1, further comprising:
a second user authentication information registering unit configured to register identification (ID) card image of the user;
a user ID card image obtaining unit configured to obtain a user ID card image by the live image capture; and
a second authentication processing unit configured to compare the user ID card image obtained by the user ID card image obtaining unit with the user ID card image registered by the second user authentication information registering unit and additionally determine whether the user is authenticated according to the compared result.

3. The non-face-to-face authentication system of claim 1, wherein the first user authentication information registering unit includes:
a user face image registration guidance unit configured to guide the user to capture user face images for every a plurality of different image capture angles; and
a user face image learning and storing unit configured to classify and receive user face images captured by an image capture means depending on guidance through the user face image registration guidance unit, extract and learn feature points of a user face from the user face image classified for each image capture angle, and store the learned data.

4. The non-face-to-face authentication system of claim 1, wherein the user face image obtaining unit includes:
an image capture direction information generator configured to generate the plurality of pieces of image capture direction information about the user face and randomly generate an image capture order for an image capture direction;
an image capture guidance message providing unit configured to generate and provide an image capture guidance message according to the image capture direction information generated by the image capture information generator; and
a user face image storing unit configured to sequentially obtain user face images according to the image capture guidance message by an image capture means, determine whether the obtained user face image is a user face image according to the image capture guidance message, output the image capture guidance message again to obtain a user face image suitable for an image capture angle, when a user face image different from an image capture direction is obtained, and match and store the obtained user face image and image capture direction information included in the image capture guidance message.

5. The non-face-to-face authentication system of claim 4, wherein the first authentication processing unit includes:
a user face similarity calculating unit configured to compare first feature points in the user face image for each image capture direction, the user face image being captured and stored by the user face image storing unit, with second feature points in the user face image registered by the user face image obtaining unit and calculate a similarity between the first feature points and the second feature points; and
an authentication determining unit configured to complete the authentication of the user, when the similarity for each user face image or each image capture angle, the similarity being calculated by the user face similarity calculating unit, is greater than or equal to a predetermined reference similarity.
